(19) United States
(12) Patent Application Publication
(10) Pub. No.: US 2004/0256354 A1
(43) Pub. Date: Dec. 23, 2004

(54) Method of removing etch veils from microstructures

(76) Inventors: Raluca Dinu, Redmond, WA (US); Jeffrey K. Kressbach, Snohomish, WA (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/464,214

(22) Filed: Jun. 18, 2003

(51) Int. Cl. B29D 11/00

(52) U.S. Cl. 216/24

(57) ABSTRACT

A method for removing etch veils from the surface of a microstructure using a liquid spray directed at the surface. The spray pressure is sufficiently high to substantially remove the etch veils.

### BACKGROUND OF THE INVENTION

All patents, patent applications, and publications cited within this application are incorporated herein by reference to the same extent as if each individual patent, patent application or publication was specifically and individually incorporated by reference.

The invention relates generally to use of photolithographic and dry etching techniques to define microstructures in inorganic and organic materials. The use of dry etching (i.e., plasma etching) of lithographically defined microstructures is well known to those skilled in the arts of microelectronics, semiconductors, and photonics. Typically, a microstructure is produced in a material by a process of 1) exposing a resist that is disposed on a material to radiation through a lithographic mask that shields part of the resist from the radiation, thereby chemically changing the parts of the resist that are irradiated relative to the parts that are shielded; 2) removing one of the parts of the resist layer (also referred to as “developing”), thereby uncovering portions of a material; 3) treating the uncovered portions of material and remaining resist portions with a reactive ion plasma (i.e., dry etching) to remove portions of material and in some cases portions of the resist; and 5) removing the remaining photoresist (also referred to as “stripping”) to leave behind a microstructure in the material.

In some cases, the material that is being dry etched is sometimes redeposited on the microstructure that is forming throughout the process. The unwanted deposits are often referred to as “veils,” “etch veils,” “etch fences,” or “rabbit ears.” A schematic diagram of an etch veil formation is shown in FIG. 1. A resist (1) is disposed on material (2) to be etched on a substrate (3). The resist (1) is exposed to radiation (4) through a lithographic mask (5). The exposed resist is developed (i.e., in this example the resist is “positive tone”) to give the remaining resist (1) and the exposed surface of the material (2). The material (2) and resist (1) are dry etched with a plasma (6) that removes the material. Any resist remaining after the dry etching step can be removed by techniques such as, for example, solvent stripping. The etch veils (7) are then apparent on the microstructure and often interfere with the microstructure's function. Methods have been devised to remove the veils including using different dry etching conditions after the main etch, reacting the etch veil with wet chemicals and cleaning solutions, and chemical and mechanical brushing of the microstructure. However, these techniques can sometimes to do undesirable modification to the microstructure or may cause undesirable dislocation of the microstructure on or from the surface of the substrate. Such techniques are particularly disadvantageous when the surface quality or shape integrity of the microstructure will critically affect performance. Therefore, a need exists for methods that do not require prolonged dry etching, reactive chemical cleaning, or mechanical brushing.

### SUMMARY OF THE INVENTION

A method is described that uses a liquid spray emanating from a nozzle positioned at an angle relative to a microstructure-containing substrate to remove etch veils from the microstructure surface. The microstructure can comprise materials including metals, organically modified ceramics (ormocers), polymers, and combinations thereof. When the pressure of the spray is sufficiently high, the etch veil is removed without damage to the microstructure that may result from removal by prolonged dry etching, chemical reaction, or mechanical polishing. In some cases the liquid preferably comprises a surfactant to help remove the dislodged etch veils from the surface.

The details of one or more embodiments of the invention are set forth in the accompanying drawings and the description below. Other features, objects, and advantages will be apparent from the description and drawings, and from the claims.

### BRIEF DESCRIPTION OF THE DRAWINGS

FIG. 1 is a schematic representation of the formation of an etch veil after a typical lithography and dry etching sequence.

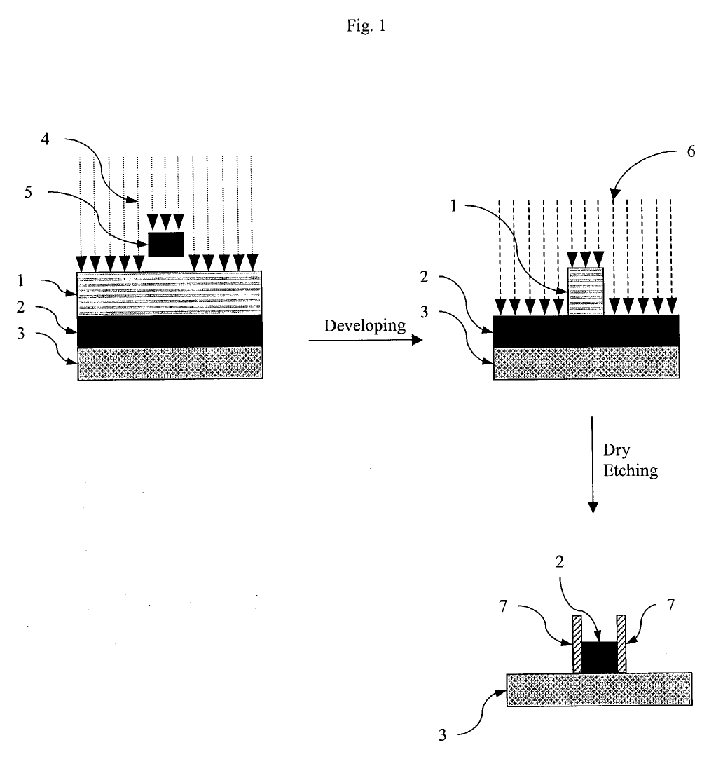

FIG. 2 is a schematic representation of a spraying method for removing etch veils from a microstructure.

### DETAILED DESCRIPTION

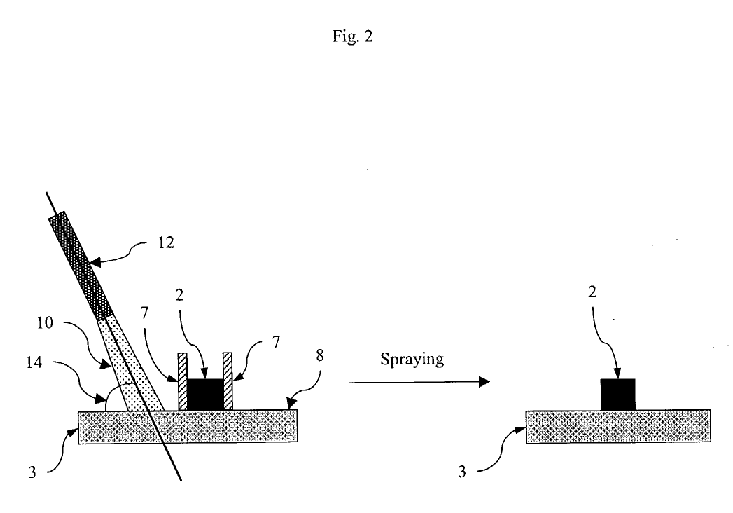

In one embodiment, referring to FIG. 2, a method comprises providing a microstructure (2) on a surface (8) of a substrate (3), the microstructure having an etch veil (7) and spraying the microstructure (2) with a spray (10) comprising a liquid, the spray having sufficient pressure to remove the etch veil (6). The spray emanates from a nozzle (12) having an angle (14) to the surface of the substrate (3). The microstructure can comprise any materials including metals, organically modified ceramics (ornocers), or polymers. The materials may be conductors, semiconductors, or insulators. Preferably, the microstructure comprises a polymer. The liquid can be chosen from any liquid that does not dissolve the microstructure or cause unwanted modifications. For example the microstructure may be soluble in polar solvents, in which case a nonpolar liquid would be preferable, or the microstructure may be soluble in polar solvents, in which case a nonpolar liquid would be preferable. Solutions comprising a chemical that reacts with the etch veil can be used as the liquid as long as the chemical does not cause unwanted modification to the microstructure. Organic polymers can be made solvent resistant by crosslinking, which is known to those skilled in the art. In some embodiments, the microstructure comprises a crosslinked polymer. When the microstructure is a polymer, preferably the microstructure is a passive optical waveguide, a thermo-optically active waveguide, an electro-optically waveguide, or an optical interconnect.

Preferably, the liquid is chosen from the group consisting of water, alcohols, and polar aprotic solvents. Polar aprotic solvents are known in the art and include solvents such as dimethylsulfoxide (DMSO), dimethylformamide (DMF), and N-methylpyrrolidinone (NMP). In some cases, the liquid preferably comprises a surfactant to help remove the dislodged etch veils from the surface (8). When the pressure of the spray is sufficiently high, the etch veil is removed without damage to the microstructure that may result from removal by chemical reaction or mechanical polishing. In preferred embodiments, the spray has a pressure of from about 30 psi to about 100 psi. The angle (14) of the spray (10) to the surface (8) should be chosen to optimize veil removal without causing unwanted damage to the microstructure or unwanted dislodging of the microstructure from the surface (8). Preferably, the spray has an angle to the surface of at least about 30°.

In some embodiments, the resist used during dry etching may remain on the microstructure afterwards. Preferably, the remaining resist is removed from the microstructure after dry etching and before spraying. The remaining resist can be removed by any method that does not cause unwanted modification of the microstructure including developing the photoresist after flood exposure, stripping the resist with a solvent, or peeling the resist from the microstructure.

### EXAMPLES

The following example(s) is illustrative and does not limit the claims.

In the following example the polymer microstructure is a Mach-Zehnder modulator dry etched with techniques like those disclosed in co-pending U.S. application Ser. No. 10/264,461. The substrate was a 6-inch silicon wafer coated with an organically modified sol gel like that described in co-pending, commonly assigned U.S. application Ser. No. 10/341,828. The microstructure comprised a crosslinked polymer like those described in the co-pending, commonly assigned U.S. application Ser. No. 10/395,610. The wafer was flood exposed to UV light at 365 nm for 20 seconds and developed in a solution of deionized water/AZ 400K developer (3:1) for 3 minutes to remove the remaining photoresist. The wafer was cleaned with 6 dump-rinse cycles of deionized water and immersed in a solution of 0.01% Triton X-100/deionized water for 10 seconds. The microstructure was sprayed with Shipley MF-24A developer at 80 psi with 600 flat spray nozzle in 3 passes, one pass at a 45° to the surface, one pass at a 90° angle to the surface, and one pass at a 135° to surface. All passes were parallel to the length of the Mach-Zehnder modulator. The wafer was dump-rinsed in deionized water for 6 cycles and spin/rinse dried in deionized water/N₂. Examination of the wafer revealed that the etch veils were removed from the microstructures.

Other embodiments are within the following claims.

1. A method, comprising: a) providing a microstructure on a surface of a substrate, the microstructure having an etch veil and b) spraying the microstructure with a spray comprising a liquid, the spray having sufficient pressure to substantially remove the etch veil.

2. The method of claim 1, wherein the microstructure comprises a metal, ormocer, or polymer.

3. The method of claim 1, wherein the microstructure comprises a conductor, semi-conductor, or insulator.

4. The method of claim 1, wherein the microstructure comprises a resist, the method further comprising removing the resist from the microstructure before spraying.

5. The method of claim 4, comprising removing the resist by developing, stripping, peeling, or a combination thereof.

6. The method of claim 1, wherein the spray has a pressure of from about 30 psi to about 100 psi.

7. The method of claim 1, wherein the liquid is chosen from the group consisting of water, alcohols, polar aprotic solvents, and combinations thereof.

8. The method of claim 1, wherein the liquid further comprises a surfactant.

9. The method of claim 1, wherein the liquid comprises a chemical that reacts with the etch veil.

10. The method of claim 1, comprising spraying the microstructure using a spray nozzle positioned at an angle relative to the substrate surface of at least about 30°.

11. The method of claim 1, wherein the microstructure comprises a polymer.

12. The method of claim 11, wherein the polymer is a crosslinked polymer.

13. The method of claim 12, wherein the liquid is a polar aprotic solvent.

14. The method of claim 13, wherein the liquid is selected from the group consisting of dimethylsulfoxide, dimethylformamide, N-methylpyrrolidinone, and combinations thereof.

15. The method of claim 11, wherein microstructure is a passive optical waveguide, a thermo-optically active waveguide, an electro-optically waveguide, or an optical interconnect.
